(19) United States
(12) Patent Application Publication
(10) Pub. No.: US 2026/0268913 A1
(43) Pub. Date: Sep. 10, 2026

(54) CODING OF FRAME-LEVEL OUT-OF-SYNC METADATA

(71) Applicant: NOKIA TECHNOLOGIES OY, Espoo (FI)

(72) Inventors: Jouni Kristian PAULUS, Hersbruck (DE); Mikko-Ville LAITINEN, Espoo (FI); Lasse Juhani LAAKSONEN, Tampere (FI); Tapani PIHLAJAKUJA, Kellokoski (FI); Anssi Sakari RÄMÖ, Tampere (FI)

(21) Appl. No.: 19/166,405

(22) PCT Filed: Feb. 13, 2024
(86) PCT No.: PCT/EP2024/053524

§ 371 Date: Sep. 17, 2025

(30) Foreign Application Priority Data
Mar. 24, 2023 (GB) 2304318.5

(51) Int. Cl. G10L 19/00

(52) U.S. Cl. CPC G10L 19/00

(57) ABSTRACT

An apparatus comprising means for: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; processing the frame comprising the at least two time sub-frames based on the asynchrony information, such that the processed frames comprising the at least two time sub-frames of at least one spatial metadata parameter is able to be further processed.

### FIELD

The present application relates to apparatus and methods for coding frame-level out-of-sync metadata.

### BACKGROUND

Parametric spatial audio capture from inputs, such as microphone arrays and other sources, is a typical and an effective choice to estimate from the input (microphone array signals) a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total and diffuse-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and, for example, a stereo or mono transport audio signal can be generated from the microphone array signals to be conveyed with the spatial metadata.

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as, for example, immersive voice and audio for virtual reality (VR). This audio codec is expected to handle the encoding, decoding, and rendering of speech, music, and generic audio. It is furthermore expected to support channel-based audio, object-based audio, and scene-based audio inputs including spatial information about the sound field and sound sources. The codec is also expected to operate with low latency to enable conversational services as well as support high error robustness under various transmission conditions.

The transport audio signal could be encoded, for example, using an IVAS audio core codec, or with an AAC (Advanced Audio Coding) or EVS (Enhanced Voice Services) encoder. A decoder can decode the audio signals into PCM (Pulse code modulation) signals and process the sound in frequency bands (using the spatial metadata) to obtain the spatial output, for example, a binaural output.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is provided an apparatus comprising means for: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; and processing the frame comprising the at least two time sub-frames based on the asynchrony information, such that the processed frame comprising the at least two time sub-frames of at least one spatial metadata parameter is able to be further processed.

The sequence of at least two time sub-frames containing similar values may be one of: located within the same frame; and located over two consecutive frames.

The means may be for further processing the processed frame comprising the at least two time sub-frames of at least one spatial metadata parameter.

The means for further processing the at least one spatial metadata parameter processed frame comprising the at least two time sub-frames may be for encoding the processed frame comprising the at least two time sub-frames of at least one spatial metadata parameter.

The means may be further for: obtaining the at least one audio signal; and encoding the at least one audio signal.

The means for obtaining asynchrony information may be for one of: analysing the at least one spatial metadata parameter to determine the asynchrony information; receiving the asynchrony information from at least one further apparatus having determined the asynchrony information; and receiving the asynchrony information from at least one further apparatus having analysed the at least one spatial metadata parameter to determine the asynchrony information.

The means for obtaining asynchrony information may be for obtaining an offset value identifying a temporal difference between the sequence of at least two time sub-frames and the encoding frame, the temporal difference obtained as a number of sub-frames.

The means for processing the sequence of the at least two time sub-frames based on the asynchrony information may be for processing the at least one spatial metadata parameter based on the offset value.

The means for processing the at least one spatial metadata parameter based on the offset value may be for generating a single spatial metadata parameter sub-frame to represent the at least two time sub-frames based on the processing of the sequence of the at least two time sub-frames.

The means for generating a single spatial metadata parameter sub-frame to represent the at least two time sub-frames based on the processing of the sequence of the at least two time sub-frames may be for one of: selecting one of the at least two sub-frames to be the single spatial metadata parameter sub-frame; and determining an aggregation of the at least two sub-frames to be the single spatial metadata parameter sub-frame.

The means for determining an aggregation of the at least two sub-frames to be the single spatial metadata parameter sub-frame may be for one of: determining an aggregation function based on a vector average of a directional component of the at least one spatial metadata parameter; determining an aggregation function based on a vector average of a directional component of the at least one spatial metadata parameter weighted by a signal energy weighting.

The means for obtaining asynchrony information may be for obtaining an encoding mode identifying an encoding mode for encoding the at least one spatial metadata parameter based on the asynchrony information.

The means for analysing the at least one spatial metadata parameter to determine the asynchrony information may be for: analysing for a current frame at least one spatial metadata parameter associated with the at least one audio signal to determine: a number of mutually similar sub-frames from the current frame start and a number of mutually similar sub-frames from the current frame end; and determining the asynchrony information based on the number of mutually similar sub-frames from the current frame start and/or the number of mutually similar sub-frames from the current frame end.

The means for analysing the at least one spatial metadata parameter to determine the asynchrony information may be further for: analysing for a last-sub-frame of a previous frame and a first-sub-frame of a current frame whether these are mutually similar sub-frames; and obtaining for the previous frame a number of mutually similar sub-frames, wherein the means for determining the asynchrony information based on the number of mutually similar sub-frames from the current frame start and/or the number of mutually similar sub-frame from the current frame end is further for determining the asynchrony information based on whether the last-sub-frame of a previous frame and a first-sub-frame of a current frame are mutually similar sub-frames and the number of mutually similar sub-frames for the previous sub-frame.

According to a second aspect there is provided a method for an apparatus, the method comprising: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; and processing the frame comprising the at least two time sub-frames based on the asynchrony information, such that the processed frames comprising the at least two time sub-frames at least one spatial metadata parameter is able to be further processed.

The sequence of at least two time sub-frames containing similar values may be one of: located within the same frame; and located over two consecutive frames.

The method may further comprise processing the processed sequence of the at least two time sub-frames of at least one spatial metadata parameter.

Further processing the at least one spatial metadata parameter processed frame comprising the at least two time sub-frames may comprise encoding the processed frame comprising the at least two time sub-frames of at least one spatial metadata parameter.

The method may further comprise: obtaining the at least one audio signal; and encoding the at least one audio signal.

Obtaining asynchrony information may comprise one of: analysing the at least one spatial metadata parameter to determine the asynchrony information; receiving the asynchrony information from at least one further apparatus having determined the asynchrony information; and receiving the asynchrony information from at least one further apparatus having analysed the at least one spatial metadata parameter to determine the asynchrony information.

Obtaining asynchrony information may comprise obtaining an offset value identifying a temporal difference between the sequence of at least two time sub-frames and the encoding frame, the temporal difference obtained as a number of sub-frames.

Processing the sequence of the at least two time sub-frames based on the asynchrony information may comprise processing the at least one spatial metadata parameter based on the offset value.

Processing the at least one spatial metadata parameter based on the offset value may comprise generating a single spatial metadata parameter sub-frame to represent the at least two time sub-frames based on the processing of the sequence of the at least two time sub-frames.

Generating a single spatial metadata parameter sub-frame to represent the at least two time sub-frames based on the processing of the sequence of the at least two time sub-frames may comprise one of: selecting one of the at least two sub-frames to be the single spatial metadata parameter sub-frame; and determining an aggregation of the at least two sub-frames to be the single spatial metadata parameter sub-frame.

Determining an aggregation of the at least two sub-frames to be the single spatial metadata parameter sub-frame may comprise one of: determining an aggregation function based on a vector average of a directional component of the at least one spatial metadata parameter; determining an aggregation function based on a vector average of a directional component of the at least one spatial metadata parameter weighted by a signal energy weighting.

Obtaining asynchrony information may comprise obtaining an encoding mode identifying an encoding mode for encoding the at least one spatial metadata parameter based on the asynchrony information.

Analysing the at least one spatial metadata parameter to determine the asynchrony information may comprise: analysing for a current frame at least one spatial metadata parameter associated with the at least one audio signal to determine: a number of mutually similar sub-frames from the current frame start and a number of mutually similar sub-frames from the current frame end; and determining the asynchrony information based on the number of mutually similar sub-frames from the current frame start and/or the number of mutually similar sub-frames from the current frame end.

Analysing the at least one spatial metadata parameter to determine the asynchrony information may further comprise: analysing for a last-sub-frame of a previous frame and a first-sub-frame of a current frame whether these are mutually similar sub-frames; and obtaining for the previous frame a number of mutually similar sub-frames, wherein determining the asynchrony information based on the number of mutually similar sub-frames from the current frame start and/or the number of mutually similar sub-frame from the current frame end further comprises determining the asynchrony information based on whether the last-sub-frame of a previous frame and a first-sub-frame of a current frame are mutually similar sub-frames and the number of mutually similar sub-frames for the previous sub-frame.

According to a third aspect there is provided an apparatus comprising at least one processor and at least one memory storing instructions that, when executed by the at least one processor, cause the system at least to perform: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; and processing the frame comprising the at least two time sub-frames based on the asynchrony information, such that the processed frame comprising the at least two time sub-frames of at least one spatial metadata parameter is able to be further processed.

The sequence of at least two time sub-frames containing similar values is one of: located within the same frame; and located over two consecutive frames.

The apparatus may be further caused to perform further processing the processed frame comprising the at least two time sub-frames at least one spatial metadata parameter.

The apparatus caused to perform further processing the at least one spatial metadata parameter processed frame comprising the at least two time sub-frames may be further caused to perform encoding the processed frame comprising the at least two time sub-frames of at least one spatial metadata parameter.

The apparatus may be further caused to perform: obtaining the at least one audio signal; and encoding the at least one audio signal.

The sequence of at least two sub-frames may be further arranged as frames comprising two or more sub-frames.

The apparatus caused to perform obtaining asynchrony information may be caused to perform one of: analysing the at least one spatial metadata parameter to determine the asynchrony information; receiving the asynchrony information from at least one further apparatus having determined the asynchrony information; and receiving the asynchrony information from at least one further apparatus having analysed the at least one spatial metadata parameter to determine the asynchrony information.

The apparatus caused to perform obtaining asynchrony information may be further caused to perform obtaining an offset value identifying a temporal difference between the sequence of at least two time sub-frames and the encoding frame, the temporal difference obtained as a number of sub-frames.

The apparatus caused to perform processing the sequence of the at least two time sub-frames based on the asynchrony information may be further caused to perform processing the at least one spatial metadata parameter based on the offset value.

The apparatus caused to perform processing the at least one spatial metadata parameter based on the offset value may be further caused to perform generating a single spatial metadata parameter sub-frame to represent the at least two time sub-frames based on the processing of the sequence of the at least two time sub-frames.

The apparatus caused to perform generating a single spatial metadata parameter sub-frame to represent the at least two time sub-frames based on the processing of the sequence of the at least two time sub-frames may be caused to perform one of: selecting one of the at least two sub-frames to be the single spatial metadata parameter sub-frame; and determining an aggregation of the at least two sub-frames to be the single spatial metadata parameter sub-frame.

The apparatus caused to perform determining an aggregation of the at least two sub-frames to be the single spatial metadata parameter sub-frame may be further caused to perform one of: determining an aggregation function based on a vector average of a directional component of the at least one spatial metadata parameter; determining an aggregation function based on a vector average of a directional component of the at least one spatial metadata parameter weighted by a signal energy weighting.

The apparatus caused to perform obtaining asynchrony information may be further caused to perform obtaining an encoding mode identifying an encoding mode for encoding the at least one spatial metadata parameter based on the asynchrony information.

The apparatus caused to perform analysing the at least one spatial metadata parameter to determine the asynchrony information may be further caused to perform: analysing for a current frame at least one spatial metadata parameter associated with the at least one audio signal to determine: a number of mutually similar sub-frames from the current frame start and a number of mutually similar sub-frames from the current frame end; and determining the asynchrony information based on the number of mutually similar sub-frames from the current frame start and/or the number of mutually similar sub-frames from the current frame end.

The apparatus caused to perform analysing the at least one spatial metadata parameter to determine the asynchrony information may be further caused to perform: analysing for a last-sub-frame of a previous frame and a first-sub-frame of a current frame whether these are mutually similar sub-frames; and obtaining for the previous frame a number of mutually similar sub-frames, wherein the apparatus caused to perform determining the asynchrony information based on the number of mutually similar sub-frames from the current frame start and/or the number of mutually similar sub-frame from the current frame end is further caused to perform determining the asynchrony information based on whether the last-sub-frame of a previous frame and a first-sub-frame of a current frame are mutually similar sub-frames and the number of mutually similar sub-frames for the previous sub-frame.

According to a fourth aspect there is provided an apparatus comprising: obtaining circuitry configured to obtain at least one spatial metadata parameter associated with at least one audio signal, the at least one spatial metadata parameter being arranged in frames comprising at least two sub-frames; obtaining circuitry configured to obtain asynchrony information, wherein the asynchrony information is based on asynchrony between a sequence of at least two time sub-frames containing similar values and a frame for further processing the at least one spatial metadata parameter; and processing circuitry configured to process the frame comprising the at least two time sub-frames based on the asynchrony information, such that the processed frames comprising the at least two time sub-frames of at least one spatial metadata parameter is able to be further processed.

According to a fifth aspect there is provided a computer program comprising instructions [or a computer readable medium comprising program instructions] for causing an apparatus to perform at least the following: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; and processing the frame comprising the at least two time sub-frames based on the asynchrony information, such that the processed frames comprising the at least two time sub-frames of at least one spatial metadata parameter is able to be further processed.

According to a sixth aspect there is provided a non-transitory computer readable medium comprising program instructions for causing an apparatus to perform at least the following: obtaining at least one spatial metadata parameter associated with at least one audio signal, the at least one spatial metadata parameter being arranged in frames comprising at least two sub-frames;
obtaining asynchrony information, wherein the asynchrony information is based on asynchrony between a sequence of at least two time sub-frames containing similar values and a frame for further processing the at least one spatial metadata parameter; and processing the frame comprising the at least two time sub-frames based on the asynchrony information, such that the processed frames comprising the at least two time sub-frames of at least one spatial metadata parameter is able to be further processed.

According to a seventh aspect there is provided an apparatus comprising: means for obtaining at least one spatial metadata parameter associated with at least one audio signal, the at least one spatial metadata parameter being arranged in frames comprising at least two sub-frames; means for obtaining asynchrony information, wherein the asynchrony information is based on asynchrony between a sequence of at least two time sub-frames containing similar values and a frame for further processing the at least one spatial metadata parameter; and means for processing the frame comprising the at least two time sub-frames based on the asynchrony information, such that the processed frames comprising the at least two time sub-frames of at least one spatial metadata parameter is able to be further processed.

According to an eighth aspect there is provided a computer readable medium comprising program instructions for causing an apparatus to perform at least the following: obtaining at least one spatial metadata parameter associated with at least one audio signal, the at least one spatial metadata parameter being arranged in frames comprising at least two sub-frames; obtaining asynchrony information, wherein the asynchrony information is based on asynchrony between a sequence of at least two time sub-frames containing similar values and a frame for further processing the at least one spatial metadata parameter; processing the frame comprising the at least two time sub-frames based on the asynchrony information, such that the processed frames comprising the at least two time sub-frames of at least one spatial metadata parameter is able to be further processed.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an apparatus for MASA metadata extraction;

FIG. 2 shows schematically an example MASA metadata frame sub-frame structure;

FIG. 3 shows schematically an example MASA metadata frame time-frequency structure;

FIG. 4 shows schematically an example metadata resolution adjustment and reconstruction method;

FIG. 5 shows example application scenarios showing tandem coding and multi-stream combining;

FIG. 6 shows example delays implemented by the encoder/decoder with respect to the metadata;

FIG. 7 shows example asynchrony situations in encoding/decoding the metadata;

FIG. 8 shows schematically an example system of apparatus suitable for implementing some embodiments;

FIG. 9 shows schematically timing alternatives in metadata framing according to some embodiments;

FIG. 10 shows schematically potential metadata contributions with different framing offsets between IVAS and MASA framings according to some embodiments;

FIG. 11 shows schematically a known metadata analyser and encoder;

FIG. 12 shows schematically metadata sub-frames available when constructing transport data in history and history-free or history-less modes;

FIG. 13 shows schematically an encoder suitable for employing some embodiments;

FIG. 14 shows a flow diagram of the operation of the example encoder shown in FIG. 13 according to some embodiments;

FIG. 15 shows a flow diagram of the operation of the asynchrony analyzer as shown in FIG. 13 according to some embodiments;

FIG. 16 shows schematically a decoder suitable for employing in some embodiments;

FIG. 17 shows a flow diagram of the operation of a further asynchrony analyzer example as shown in FIG. 13 according to some embodiments;

FIG. 18 shows schematically a further example system of apparatus suitable for implementing some embodiments; and

FIG. 19 shows an example device suitable for implementing the apparatus shown in previous figures.

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency.

Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy in the scene that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example, a reasonable design choice which is able to produce a good quality output is one where the spatial metadata comprises one or more directions for each time-frequency subframe (and associated with each direction direct-to-total ratios, spread coherence, distance values etc) are determined.

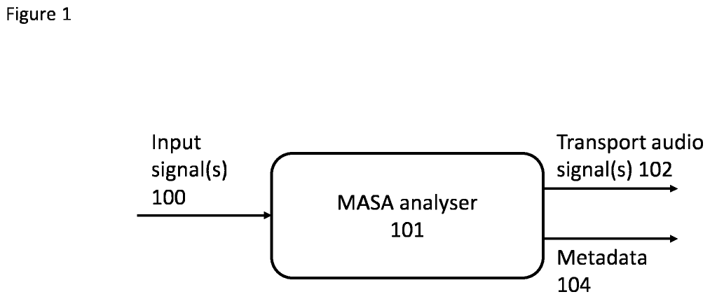

With respect to FIG. 1 is shown an example MASA analyser 101. The MASA analyser 101 is configured to receive the input audio signal(s) 100 and analyse the input audio signals to generate transport audio signal(s) 102 and spatial metadata 104.

Examples of MASA spatial metadata is presented in the following table. These values are available for each time-frequency tile. In some implementations a frame is subdivided into 24 frequency bands and 4 temporal sub-frames. In other implementations other divisions of frequency and time can be employed. Furthermore, in some implementations a frame size (for example, as implemented in IVAS) is 20 ms (and thus the temporal sub-frame is 5 ms). However, similarly, other frame lengths can be employed in other embodiments. In some embodiments the MASA analyser is configured to determine 1 or 2 directions for each time-frequency tile (i.e., there are 1 or 2 direction index, direct-to-total energy ratio, and spread coherence parameters for each time-frequency tile). However, in some embodiments the analyser is configured to generate more than 2 directions for a time-frequency tile.

| Field | bits | Description |
|---|---|---|
| Direction | 16 | Direction of arrival of the sound at a time-frequency |
| index | | parameter interval. Spherical representation at about |
| | | 1-degree accuracy. |
| | | Range of values: “covers all directions at about 1° |
| | | accuracy” |
| | | Values stored as 16-bit unsigned integers. |
| Direct-to- | 8 | Energy ratio for the direction index (i.e., time- |
| total energy | | frequency subframe). |
| ratio | | Calculated as energy in direction / total energy. |
| | | Range of values: [0.0, 1.0] |
| | | Values stored as 8-bit unsigned integers with |
| | | uniform spacing of mapped values. |
| Spread | 8 | Spread of energy for the direction index (i.e., time- |
| coherence | | frequency subframe). |
| | | Defines the direction to be reproduced as a point |
| | | source or coherently around the direction. |
| | | Range of values: [0.0, 1.0] |
| | | Values stored as 8-bit unsigned integers with |
| | | uniform spacing of mapped values. |
| Diffuse-to- | 8 | Energy ratio of non-directional sound over |
| total energy | | surrounding directions. |
| ratio | | Calculated as energy of non-directional sound / total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Surround | 8 | Coherence of the non-directional sound over the |
| coherence | | surrounding directions. |
| | | Range of values: [0.0, 1.0] |
| | | (Parameter is independent of number of directions |
| | | provided.) |
| | | Values stored as 8-bit unsigned integers with |
| | | uniform spacing of mapped values. |
| Remainder- | 8 | Energy ratio of the remainder (such as microphone |
| to-total | | noise) sound energy to fulfil requirement that sum of |
| energy ratio | | energy ratios is 1. |
| | | Calculated as energy of remainder sound / total |
| | | energy. |
| | | Range of values: [0.0, 1.0] |
| | | (Parameter is independent of number of directions |
| | | provided.) |
| | | Values stored as 8-bit unsigned integers with |
| | | uniform spacing of mapped values. |

The MASA stream can be rendered to various outputs, such as multichannel loudspeaker signals (e.g., 5.1) or binaural signals.

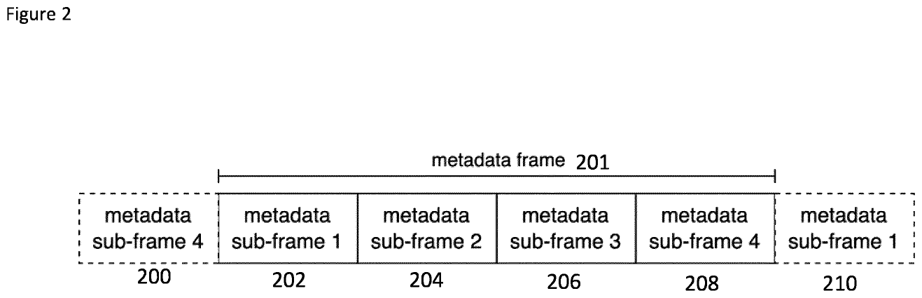

As discussed above the frame size in IVAS is 20 ms. An example of the example frame structure is shown in FIG. 2 where the metadata frame 201 comprises four temporal sub-frames which are 5 ms long. FIG. 2 shows, for example, the previous frame metadata sub-frame 4 200, then the current metadata frame 201 comprising metadata sub-frame 1 202, metadata sub-frame 2 204, metadata sub-frame 3 206, and metadata sub-frame 4 208. Following this is the succeeding or next frame metadata sub-frame 1 210.

Furthermore the IVAS codec is expected to operate at various bit rates ranging from very low bit rates (for example 13.2 kbps) to relatively high bit rates (for example 512 kbps or even 768 kbps). As the raw bit rate of the MASA metadata is about 300-500 kbps (depending on whether there are encoded one or two simultaneous directions), the metadata is significantly compressed (especially at the lowest bit rates).

One aspect of compression can be methods that reduce the temporal and/or frequency resolution of the metadata (which can be employed alongside other methods for compressing the data).

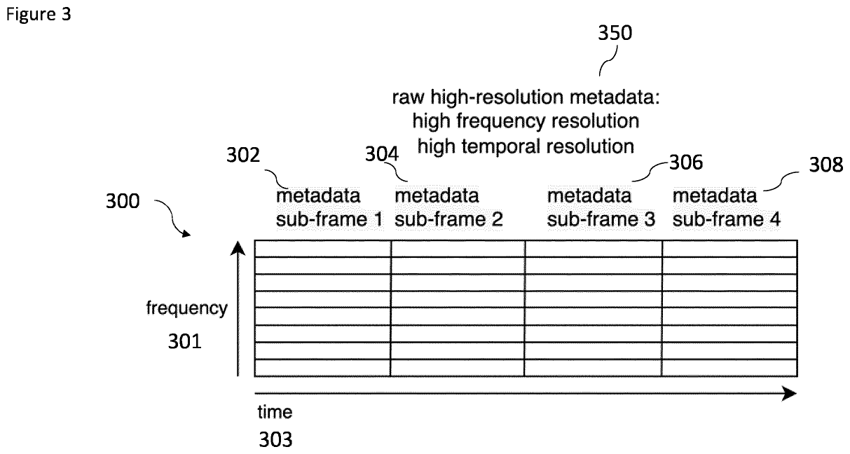

As mentioned above and as shown in FIG. 3, an example metadata frame 300 in raw high resolution 350 can comprise 24 frequency bands on the frequency axis 301 and 4 temporal subframes (sub-frames 1 to 4 302, 304, 306, 308) on the time axis 303, meaning in total 96 time-frequency tiles (also called TF-tiles).

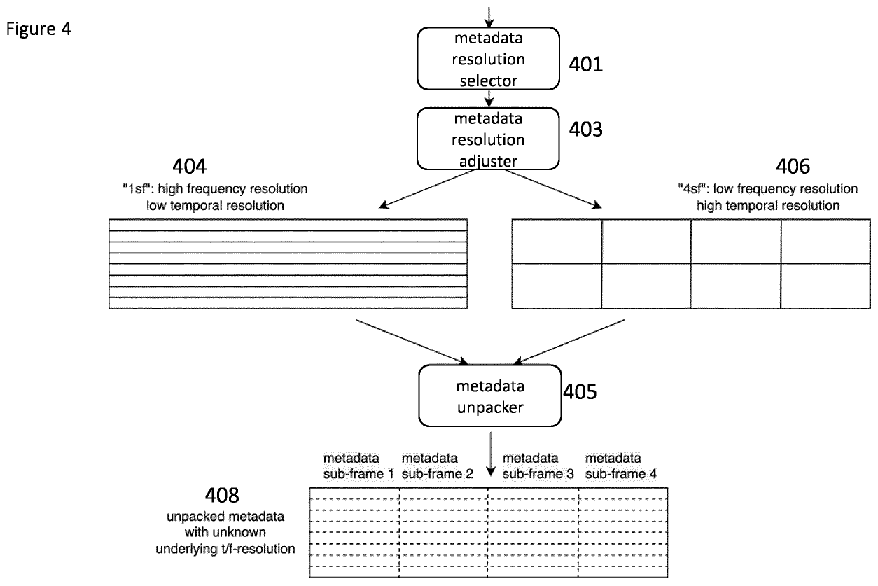

With respect to FIG. 4 is shown a method of reducing the number of time-frequency tiles to be transmitted and therefore reduce the required bitrate significantly. Such a method is described in UKIPO patent applications 1919130.3 and 1919131.1 presents methods that allow combining metadata from multiple frequency bands and/or temporal subframes to fewer frequency bands and/or temporal subframes.

As an example, such as shown in FIG. 4, depending on the bitrate, 5-24 frequency bands and 1-4 subframes may be transmitted.

Such a method therefore comprises a metadata resolution selector 401 and adjuster 403 configured to generate a 1sf, low temporal resolution (or high frequency resolution) low temporal resolution metadata frame, 404 and a 4sf, high temporal resolution (or low frequency resolution) high temporal resolution metadata frame, 406.

The metadata is unpacked in a metadata unpacker 405 which is configured to unpack the common representation resolution metadata frame 408 at the decoder (the frame having an unknown underlying TF-resolution).

As the MASA stream can be created from various types of devices (e.g., from microphone arrays on mobile devices as well as dedicated Ambisonics microphone arrays, such as the Eigenmike), the methods used for determining the spatial metadata may vary significantly between implementations. Some methods may have high temporal resolution but high temporal resolution (or low frequency resolution), whereas some methods may have low temporal resolution but low temporal resolution (or high frequency resolution).

In order to improve coding efficiency for both kind of time-frequency resolutions, it has been suggested that the MASA metadata could be encoded in two different modes as shown in PCT application WO2021250312, and also shown above in FIG. 4. The first metadata frame resolution is one having more frequency resolution (1sf) but only one temporal sub-frame per frame, the other metadata frame resolution having a high temporal resolution (or low frequency resolution) (4sf) but keeping the 4 temporal subframes.

In this example the former mode (1sf) is selected when the encoder receives spatial metadata which is determined or detected to be identical (or substantially identical or similar) over all subframes of the frame.

If the spatial metadata is not identical (or not substantially identical or not similar) over all subframes then the latter mode (4sf) is employed.

As an example, at a certain bitrate, the former mode (1sf) may transmit 18 frequency bands and 1 subframe (in other words a total of 18 TF-tiles), and the latter mode (4sf) may transmit 5 frequency bands and 4 subframes (in other words a total of 20 TF-tiles) which roughly equates to similar size of transmitted data at the same overall bit rate.

In PCT application WO2019105575, it has been proposed to use variable input metadata time-frequency resolution. This achieves a similar trade-off as methods of PCT application WO2021250312, however the decision is implemented outside of the codec and can be based on the specific capture algorithm for the microphone array being used.

The methods described above therefore show ways to permit an encoding quality to be maintained, where the temporal and the frequency resolution is tuned or adjusted with respect to the audio input.

As discussed about these methods select the low temporal resolution (or high frequency resolution) mode when all the subframes of the frame have identical (or substantially identical or at least similar-enough) data. A microphone front-end which creates the MASA stream can create the metadata in a way that this is true, but cannot guarantee that the sub-frames are always synchronised. In other words, metadata framing may show asynchrony.

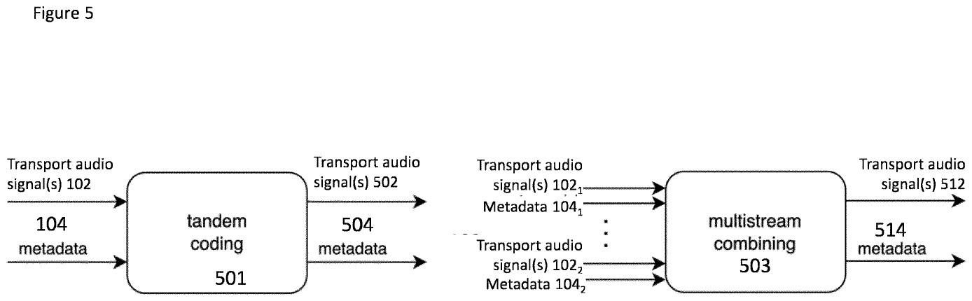

Examples of application scenarios which may introduce metadata framing asynchrony are shown with respect to FIG. 5. For example, on the left side of FIG. 5 shows a tandem coder 501 which is configured to receive as inputs transport signals 102 and metadata 104 in which the metadata (and transport audio) stream was already encoded and then decoded, and it is provided as an input to a second encoder, the tandem coder 501 configured to generate an output transport signal(s) 502 and metadata 504. In this example it cannot be guaranteed that the framing (or sub-frame grouping) of this second encoding implemented by the tandem coder 501 matches the earlier encoder.

Furthermore the right side of FIG. 5 shows a MCU (Multipoint Control Unit) application where a multi-stream combiner 503 is configured to combine multiple transport 1021, 1022 and metadata 1041, 1042 streams into one stream to generate an output transport signal(s) 512 and metadata 514. Once again it cannot be guaranteed that the synchronization of the framing in the MCU is the same as in all combined streams.

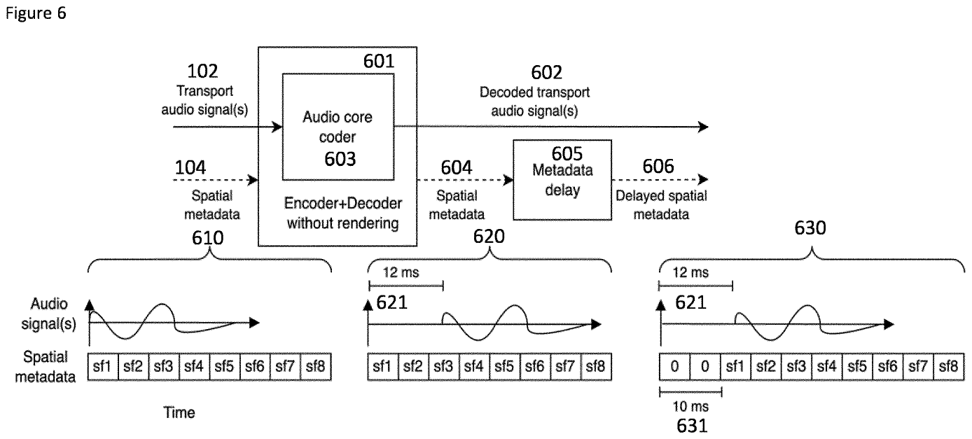

With respect to FIG. 6 is shown the timing delays which can be experienced in both scenarios within an example system. The MASA stream (comprising the input transport audio signals 102 and metadata 104) can be obtained by the system 601. The system 601 can be effectively considered to comprise an encoder, which is configured to generate a bitstream and decoder which is configured to receive the bitstream and configured to provide an example output comprising a transport audio signal(s) and spatial metadata. These are shown combined into a single schematic system block. The system 601 in some embodiments the system can be considered to comprise an audio core coder 603 configured to implement an IVAS codec (which for example has 32 ms of delay for the MASA format) configured to generate the decoded transport audio signals 602. This MASA example delay of 32 ms comprises 20 ms of framing delay and 12 ms of look-ahead delay for the audio core coder. This look-ahead delay corresponds to the delay of (approximately) 2 subframes (2×5 ms=10 ms≈12 ms). The metadata delay 605 can be applied to apply a 2 sub-frame look-ahead delay to the metadata to generate delayed spatial metadata 606 in an attempt to re-align the decoded transport audio signals and spatial metadata.

Thus, for example, the input situation 610 is one in which the audio signals and spatial metadata are aligned.

Then following the application of the encoder/decoder, the post-codec situation 620, shows that the decoded transport audio signals are delayed 621, for example by 12 ms, with respect to the spatial metadata.

Then following the application of the metadata delay, the post-delay situation 630, shows that the application of the 2 sub-frame look ahead delay 631 to the metadata approximately matches the decoding delay 621 and therefore approximately re-synchronizes the decoded transport audio signals and the delayed spatial metadata.

Although this delay resolution of the delay relative to the sub-frames of the metadata can cause synchronization issues this does not cause significant perceptual issues. However, the introduction of the framing offset relative to a ‘global’ clock, in other words the delayed spatial metadata and any further encoding operation timing, cannot be guarantee that for a further stage that the delayed spatial metadata within a bitstream is ‘frame’ synchronised with the further stage frame clock. For example as discussed herein there is an encoding mode where a low temporal resolution (or high frequency resolution) encoding mode is selected when the current frame has substantially similar values, where the later encoding frame is not synchronised with the delayed metadata frame then there is possibility that an encoding frame of metadata is determined to have identical values for all subframes.

For example there can be a system where an output of a decoding stage is audio with 12 ms delay and metadata with 10 ms delay and a second coding stage operates with the same global absolute framing clock as the first coding round. Because of the delays, the second encoding stage receives the audio and metadata delayed, even though the framing starts running immediately. In which case the first 12 ms of audio will be zeros and the first two metadata sub-frames will be empty before the decoded real data is available.

Therefore the first frame has half zeros and half real data (the first half of the first original frame). The second frame of the second encoding has the second half of the first original frame and the first half of the second original frame, and so forth with half-a-frame offset.

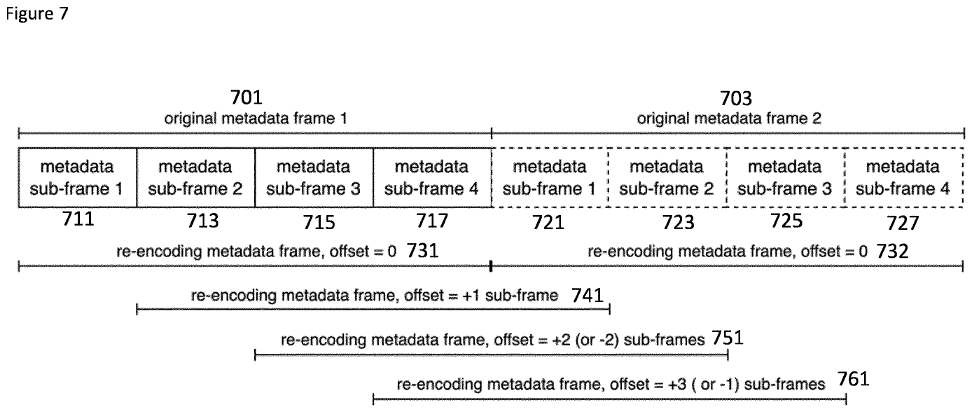

This potential asynchrony of the framing is shown with respect to FIG. 7. FIG. 7 for example shows the original metadata frame timing where there is shown a first ‘original’ metadata frame 1 701 comprising metadata sub-frame 1 711, metadata sub-frame 2 713, metadata sub-frame 3 715, metadata sub-frame 4 717, and a second ‘original’ metadata frame 2 703 comprising metadata sub-frame 1 721, metadata sub-frame 2 723, metadata sub-frame 3 725, metadata sub-frame 4 727.

Then is shown all potential 4 offset values that can take place in the 4 sub-frame case used in MASA.

For example, the offset=0 situation where a first re-encoding metadata frame, frame, 1 731 and a second re-encoding metadata frame, frame 2, 732 are completely aligned or synchronised with respective first ‘original’ metadata frame 1 701 and second ‘original’ metadata frame 2 703.

Also is shown the offset=+1 (or −3) sub-frames situation 741 applied with respect to the frame 1 (or frame 2), where the re-encoding metadata frame is shifted by 1 sub-frame with respect to the first ‘original’ metadata frame 1 701 or −3 subframes with respect to the second ‘original’ metadata frame 2 703.

Furthermore is shown the offset=+2 (or −2) sub-frames situation 751 with respect to the frame 1 (or frame 2), where the re-encoding metadata frame is shifted by 2 sub-frames with respect to the first ‘original’ metadata frame 1 701 or −2 subframes with respect to the second ‘original’ metadata frame 2 703.

Then is shown the offset=+3 (or −1) sub-frames situation 761 with respect to the frame 1 (or frame 2), where the re-encoding metadata frame is shifted by 3 sub-frames with respect to the first ‘original’ metadata frame 1 701 or −1 subframe with respect to the second ‘original’ metadata frame 2 703.

Furthermore as indicated above there can be a tandem coding situation where after editing a MASA stream and mixing multiple streams, the server is configured to encode the MASA stream once again prior to storing the signal or transmitting the signal to a user.

The encoder, when checking whether the input is identical (or similar) in all subframes and determining that it is not identical (or similar) due to the offset, would be configured to encode the spatial metadata using the “high temporal resolution mode”, 4sf, where 4 subframes are coded rather than the “low temporal resolution (or high frequency resolution) mode”, 1sf. As a result, a smaller number of frequency bands are coded, e.g., only 5 instead of 18 and the frequency resolution is compromised.

Hence, the aim of the following embodiments as discussed herein is to improve (MASA) metadata coding methods to detect the framing asynchrony (offset) from the data and address the asynchrony. This can for example be expressed in methods to more correctly identify or determine situations where a low temporal resolution (or high frequency resolution) coding mode can be employed rather than reverting to a higher temporal resolution, 4sf, coding mode even where there is asynchrony in the signals.

As such the embodiments relate to encoding of parametric spatial audio (in other words, audio signal(s) and spatial metadata), where the spatial metadata is coded in frames containing multiple frequency bands and multiple sub-frames. In some embodiments this is implemented by apparatus and methods that enable coding the spatial metadata with optimized time-frequency resolution also when the spatial metadata is not in synchronization with the framing of the stream (i.e., similar/identical data may be found in subframes of different frames).

Furthermore this can be achieved, in some embodiments, by obtaining one or more frames of spatial metadata, comparing the values of the spatial metadata in the subframes of the one or more frames to determine if the metadata framing has an offset, selecting the coding mode based on the comparison, and potentially determining new spatial metadata based on the metadata values of the sub-frames, and encoding this spatial metadata.

In some embodiments the apparatus is configured to implement a method comprising:
Analyzing the spatial metadata, and detecting the framing (i.e., sub-frame grouping) asynchrony and determining the framing offset; and
Determining new spatial metadata for this frame based on the detected offset and spatial metadata sub-frames.

In some embodiments the determination of framing asynchrony can be implemented in an apparatus separate than an apparatus performing a determination of the new spatial metadata. In other words in some embodiments the apparatus or method is one in which new spatial metadata is determined for a frame, where the determination is performed based on an input having determined that the frame has asynchrony with respect to the sub-frames. This further apparatus can, for example, determine the asynchrony information based on processing of the spatial metadata in the further apparatus (or by performing analysis on the spatial metadata following the processing). In such implementations the asynchrony information, for example, the offset values are determined and provided to the encoder as a ‘hard-coded’ value.

In some embodiments the encoder can be configured to analyse the metadata sub-frames in the current and previous frames and use the presence of multiple (e.g., 4) sub-frames with similar metadata as an indication of a potential low temporal resolution (or high frequency resolution, 1sf mode coding) grouping.

In the following examples there are 4 sub-frames in one frame, but this is a specific example, and the embodiments can be generalized into N sub-frames in one frame.

In some embodiments the apparatus and method analyse the spatial metadata from the current and earlier frames for detecting any framing asynchrony.

In such embodiments once the method has detected a non-zero framing offset and that the framing mode should be a low temporal resolution (or high frequency resolution), 1sf coding mode, the encoder can be configured to apply an aggregation/interpolation function for computing or determining new spatial metadata values from the current values of spatial metadata. These new spatial metadata values are then encoded instead of the original ones.

In such implementations an associated decoder can be any suitable known decoder (in other words the decoder is unmodified).

In some embodiments the asynchrony analyser is configured to use the spatial metadata from the current frame to be encoded without memory of the analysis of earlier metadata. These embodiments use less working memory in the analysis, but the asynchrony detection may be less reliable.

In some embodiments there can be combination of these methods where the method furthermore selects whether the analysis uses memory of the previous frame or not depending on any encoder complexity limitations. For example, in situations where the additional complexity of the asynchrony detection with memory is not a problem memory (previous determinations) can be used, but if encoder complexity is constrained, a history-free analysis can be employed.

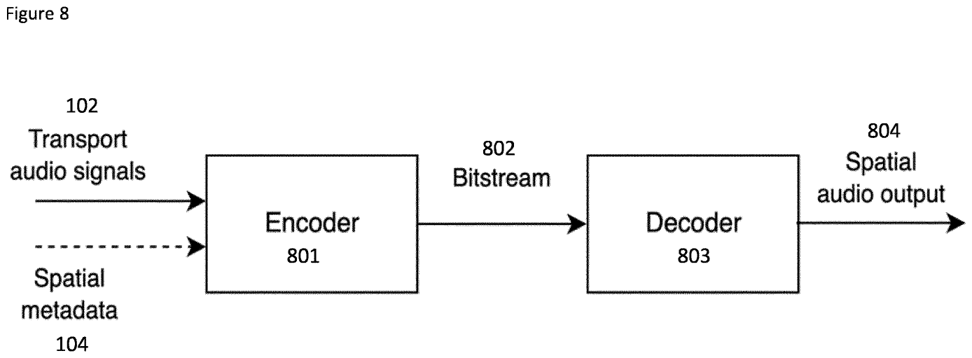

With respect to FIG. 8 is shown an example system within which some embodiments can be implemented. As an input are the transport audio signals 102 and the spatial metadata 104. The transport audio signals 102 and the spatial metadata 104 are passed to an encoder 801 which generates an encoded bitstream 802. The encoded bitstream 802 is received by the decoder 803 which is configured to generate a spatial audio output 804.

As discussed above the input to the system, the transport audio signals 102 and the spatial metadata 104 can be obtained in the form of a MASA stream. The MASA stream can, for example, originate from a mobile device (containing a microphone array), or as an alternative example, it may have been created by an audio server that has potentially processed a MASA stream in some way.

The encoder 801 can furthermore, in some embodiments, be an IVAS encoder.

The decoder 803, in some embodiments, can be configured to directly output the spatial audio output 804 to be rendered by an external renderer, or edited/processed by an audio server. In some embodiments, the decoder 803 comprises a suitable renderer, which is configured to render the output in a suitable form, such as binaural audio signals or multichannel loudspeaker signals (such as 5.1 or 7.1+4 channel format), which are also examples of spatial audio output 804.

In some embodiments the spatial metadata 104 arrives to the encoder 801 as a sequence of sub-frames with no indication of the original framing (grouping of sub-frames). If the framing of the process that provides the metadata is synchronized with the framing of the encoding process, there is no potential problem, however, if there is some asynchrony present, for example, from tandem coding or other application scenario as discussed earlier, the encoding may be sub-optimal in the sense that wrong coding mode is selected, and some data will be lost consequently.

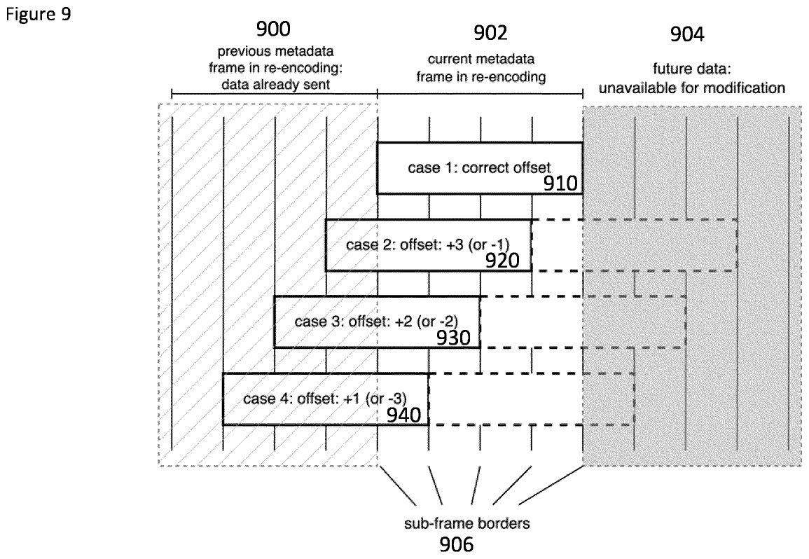

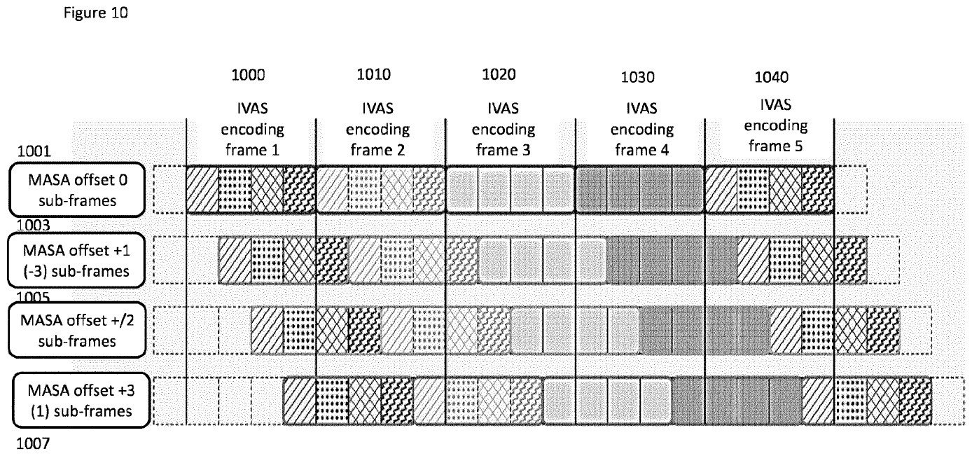

With respect to FIGS. 9 and 10 are shown example offset scenarios in the framing asynchrony. FIG. 9 for example shows a metadata framing asynchrony alternatives in the case of 4 sub-frames and the underlying MASA metadata framing. There is shown a previous metadata frame (in re-encoding data already sent) 900, a current metadata frame (in re-encoding) 902 and future data frame (unavailable for modification) 904. Each of these frames are further shown with the sub-frame borders 906.

Furthermore is shown a case 1: correct offset 910 where the framing of the input metadata is synchronised with the current frame.

Also is shown case 2: offset +3 920 where the framing of the input metadata is +3 sub-frame asynchronised with the current frame or offset −1 where the framing of the input metadata is −1 sub-frame asynchronised with the current frame.

Further is shown case 3: offset +2 930 where the framing of the input metadata is +2 sub-frame asynchronised with the current frame or offset −2 where the framing of the input metadata is −2 sub-frame asynchronised with the current frame.

Additionally is shown case 3: offset +1 940 where the framing of the input metadata is +1 sub-frame asynchronised with the current frame or offset −3 where the framing of the input metadata is −3 sub-frame asynchronised with the current frame.

FIG. 10 shows a sequence of IVAS encoding frames, frame 1 1000, frame 2 1010, frame 3 1020 and frame 4 1030.

Additionally is shown subframes in the cases where 1001 there is a 0 subframe offset, 1003 there is a +1 (or −3) subframe offset, 1005 there is a +2 (or −2) subframe offset and 1007 there is a +3 (or −1) subframe offset.

As there is no access to future metadata (causal processing) the current frame must be encoded with only the data from the current and potentially earlier frames.

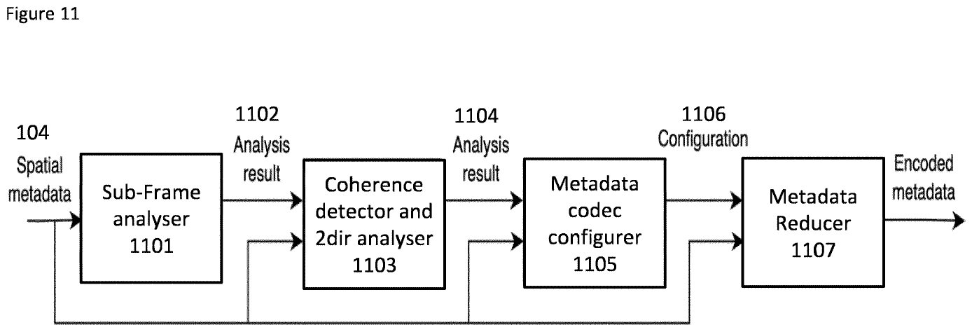

An example spatial metadata encoder is shown with respect to FIG. 11. The spatial metadata encoder is configured to operate such that when it sees 4 sub-frames with different metadata (regardless, if these are really from a frame benefiting from high temporal resolution or only because the macro-framing is not matching the original framing), the encoding uses 4sf mode for high temporal resolution, but possibly with high temporal resolution (or low frequency resolution).

As mentioned above, this may produce a sub-optimal perceptual quality.

The spatial metadata encoder is configured to receive the spatial metadata 104. The spatial metadata 104 is passed to a sub-frame analyser 1101 which is configured to analyse sub-frames in spatial metadata 104 to detect if all 4 sub-frames are similar and the 1sf coding mode could be used.

This analysis result 1102 and the spatial metadata 104 can be passed to a coherence detector and 2dir analyser 1103 which is configured to inspect the inputs and determine the presence of meaningful coherence metadata. The coherence detector and 2dir analyser 1103 furthermore can be configured to analyse the spatial metadata and determines on a per-band basis whether one or two directions should be used.

The analysis result 1104 and the spatial metadata 104 can then be passed to the metadata codec configurer 1105 which is used to generate configuration information 1106.

The configuration information 1106 and the spatial metadata 104 can then be passed to the metadata reducer 1107 configured to generate the encoded metadata 1108.

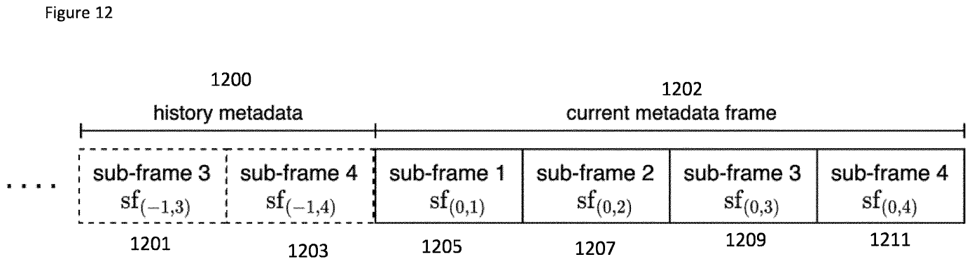

Additionally is shown with respect to FIG. 12 an example of the metadata sub-frames potentially available for analysis when encoding. Thus is shown the history metadata 1200 with sub-frame 3 sf_{(-1,3)} 1201 and sub-frame 4 sf_{(-1,4)} 1203, and the current metadata frame 1202, with sub-frame 1 sf_{(0,1)} 1205, sub-frame 2 sf_{(0,2)} 1207, sub-frame 3 sf_{(0,3)} 1209 and sub-frame 4 sf_{(0,4)} 1211. In the examples shown herein with subframe history (in other words one or more past sub-frames are stored and are available) all of the sub-frames are available but in a history-free analysis then the history metadata subframes such as sub-frame 3 1201 and sub-frame 4 1203 are not available.

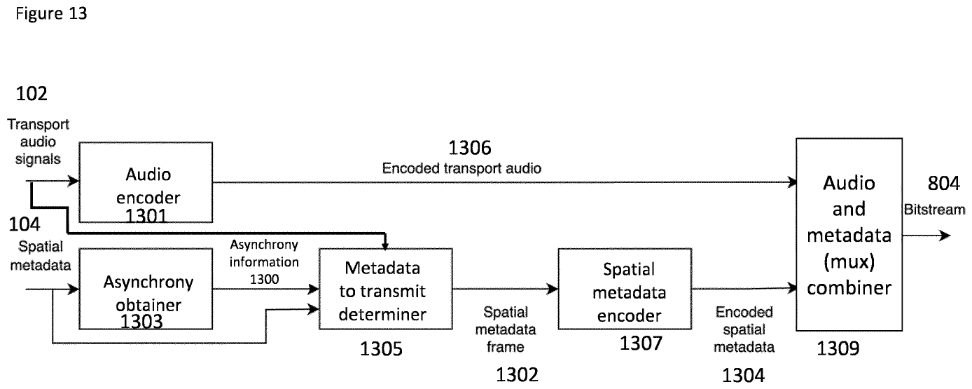

With respect to FIG. 13, there is shown in further detail an example encoder such as shown in FIG. 8 according to some embodiments. The encoder in some embodiments is configured to obtain or receive the transport audio signals 102 and pass these to the audio encoder 1301. The audio encoder 1301 is configured to generate encoded transport audio 1306 and pass this to the audio and metadata combiner (or multiplexer) 1309.

Furthermore the encoder is configured to obtain or receive spatial metadata 104 and pass this to an asynchrony analyser 1303. In some embodiments the asynchrony analyser has access to at least the sub-frame “sf(−1,4)” from the previous frame, sub-frames “sf(0,1)”, “sf(0,2)”, “sf(0,3)”, “sf(0,4)” from the current frame, and the number of mutually similar sub-frames in the end of the previous frame (which can be defined as a value of NstopPrev).

The asynchrony analyser 1303 is configured to analyse the spatial metadata 104 and generate any determined asynchrony 1300 and pass this to a metadata to transmit determiner 1305. In some embodiments the encoder does not feature an analyser 1303 and the analysis is performed elsewhere, with the encoder configured to receive the determined asynchrony information with the transport audio signals and the spatial metadata.

In some embodiments the encoder further comprises a metadata to transmit determiner 1305 configured to receive the spatial metadata 104 and the determined asynchrony 1300 and output spatial metadata frame 1302 to a spatial metadata encoder 1307. In some embodiments the metadata to transmit determiner is configured to further receive the transport audio signals in order that the determiner is able to generate weighting values for the generation of spatial metadata based on the transport signal energy in each sub-frame.

In some embodiments the encoder also comprises a spatial metadata encoder 1307 which is configured to receive the spatial metadata frame 1302 and generate encoded spatial metadata 1304 which is passed to the audio and metadata (multiplexer) combiner 1309.

The encoder furthermore comprises an audio and metadata (multiplexer) combiner 1309 configured to receive or obtain the encoded spatial metadata 1304 and the encoded transport audio 1306 and generate a bitstream 804.

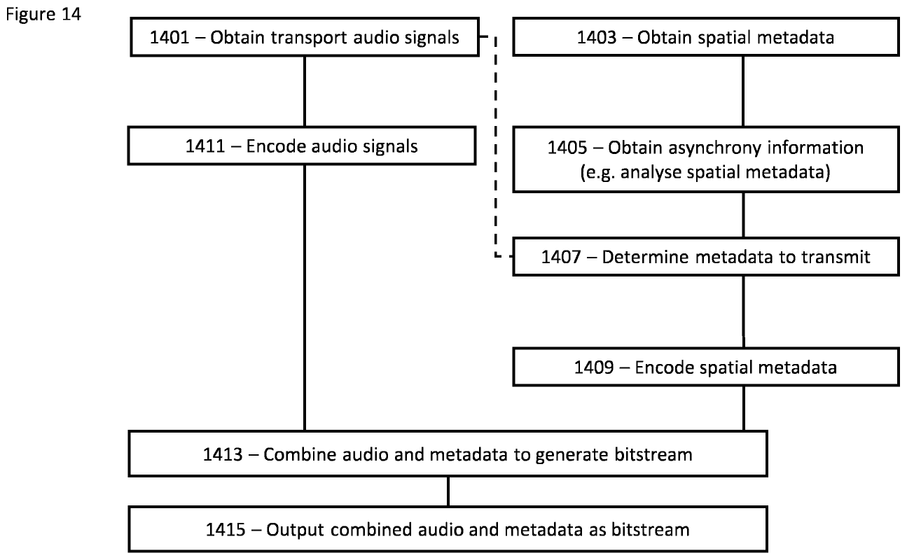

With respect to FIG. 14 is shown an example flow diagram of the operations of the encoder shown in FIG. 13.

Thus is shown obtaining transport audio signals as indicated by 1401.

Further is shown obtaining spatial metadata by 1403.

Then the encoding the audio signals is shown by 1411.

The analysis of the asynchrony with respect to the metadata is shown by 1405.

Having analysed the asynchrony within the metadata (and further optionally the obtaining of the transport audio signals) then is shown the determination of the metadata to encode for transmission (or storage) by 1407.

Then is shown by 1409 is the encoding of the determined spatial metadata.

Having encoded the transport audio signals and the metadata is the operation of combining the encoded transport audio signals and metadata to generate the bitstream as shown by 1413.

Finally the bitstream is output (either in the form of transmission or storing of the bitstream). The bitstream comprising the encoded transport audio signals and metadata as shown by 1415.

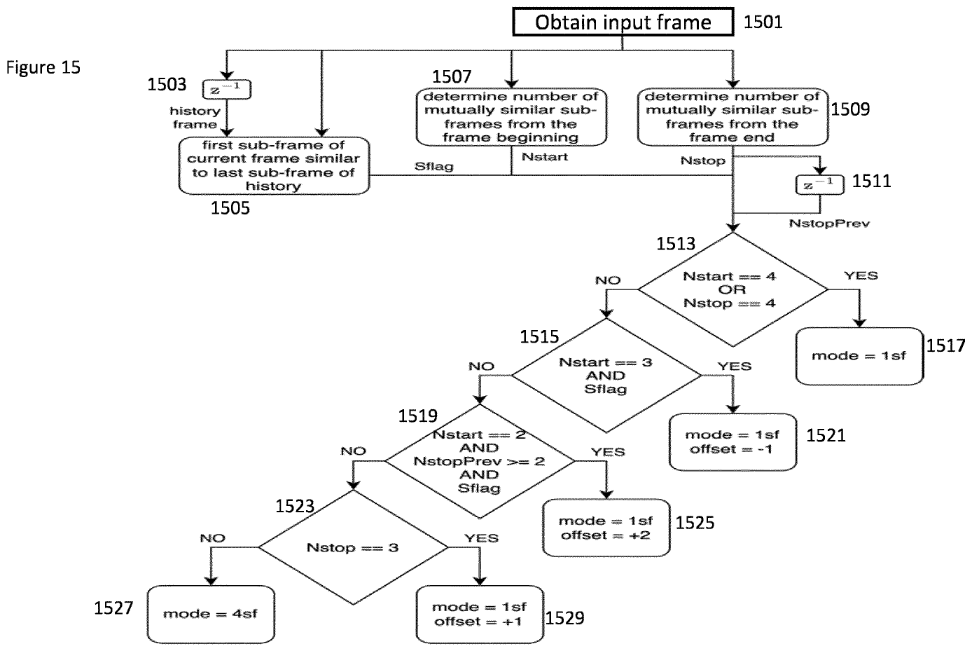

With respect to FIG. 15 is shown a further flow diagram expanding on the operations of the asynchrony analyser 1303 (Detection with memory).

In these embodiments the asynchrony analyzer 1303 is configured to obtain the input frame comprising the spatial metadata as shown by 1501.

Furthermore in some embodiments there is a delay applied as shown by 1503 to the spatial metadata and configured to delay the spatial metadata for a sub-frame. The delay effectively can be seen as generating a history frame.

Then there is shown by 1505 an operation of determining a measure of the similarity of the first sub-frame of the current frame to the last sub-frame of the history frame. This can be effectively seen as a generation of a SFlag indicator when the similarity is determined.

Furthermore as shown by 1507 is a determination of a number of mutually similar sub-frames from the frame beginning. The determination can generate a Nstart value.

There is also shown by 1509 a determination of a number of mutually similar sub-frames from the frame ending. The determination can generate a Nstop value.

The number of mutually similar sub-frames from the frame ending can furthermore be delayed as shown by 1511 to generate a NstopPrev value.

Then a determination can be made to determine whether the Nstart value is 4 or the Nstop value is 4 as shown by 1513.

If either Nstart value is 4 or the Nstop value is 4 then the determined asynchrony output is one which assigns or fixes a mode of 1sf as shown by 1517.

Else a further determination can be made to determine whether the Nstart value is 3 and there is a SFlag as shown by 1515.
If the Nstart value is 3 and there is a SFlag then the determined asynchrony output is one which assigns or fixes a mode of 1sf but with an offset value of −1 (subframe) as shown by 1521.
Else a further determination can be made to determine whether the Nstart value is 2 and the NstopPrev value is equal to or more than 2 and there is a SFlag as shown by 1519.
   If the Nstart value is 2 and the NstopPrev value is equal to or more than 2 and there is a SFlag then the determined asynchrony output is one which assigns or fixes a mode of 1sf but with an offset value of +2 (subframe) as shown by 1525.
   Else a further determination can be made to determine whether the Nstop value is 3 as shown by 1523.
      If the Nstop value is 3 then the determined asynchrony output is one which assigns or fixes a mode of 1sf but with an offset value of +1 (subframe) as shown by 1529.
      Else the determined asynchrony output is one which assigns or fixes a mode of 4sf as shown by 1527.

In this example the current spatial metadata frame is denoted as input frame, and the previous spatial metadata frame denoted as history frame. For the analysis, the history frame can be (a part of it—for example, only the last sub-frame of the previous frame.)

The analysis therefore uses two parts of historical information: number of similar sub-frames in the end of the previous frame (NstopPrev), and an indication if the first sub-frame of the current frame is similar to the last sub-frame of the previous frame (Sflag) determined using the history frame and input frame.

In these examples the definition of similarity is not critical and can be any suitable measure of similarity. One implementation of similarity could be where two sub-frames are interchanged and the output signal is perceptually similar to the original signal).

An example similarity test can, in some embodiments, be implemented by comparing the spatial metadata fields element-by-element, and if the difference of the value in some field is larger than a given threshold value, the two metadata are different. If the metadata are not different, they are similar.

For example, the following can be implemented as a similarity check:

Check the directional spatial metadata fields that are populated (1 or 2 directions are active).

Check the spatial metadata parameters in each time-frequency tile.
If the difference in the azimuth parameter is larger than a given threshold, e.g., 0.5 degrees, the metadata are different.
If the difference in the elevation parameter is larger than a given threshold, e.g., 0.5 degrees, the metadata are different.
If the difference in direct-to-total energy ratio parameters is larger than a given threshold, e.g., 0.1, the metadata are different.
If the difference in the spread coherence parameter is larger than a given threshold, e.g., 0.1, the metadata are different.
If the difference in surround coherence parameters is larger than a given threshold, e.g., 0.1, the metadata are different.

However, any suitable similarity test can be implemented. For example, direction and direct-to-total ratio can be compared using an importance measure such as presented in UKIPO patent applications 1919130.3 and 1919131.1 and PCT patent application WO2021/130405, that is, compare direction vectors which have length of direct-to-total ratio.

This history information allows detecting 1sf frames across encoding frame borders. The result of the analysis process is that the determined asynchrony 1300 enables the decision of the coding mode (1sf or 4sf) and the detected framing offset (0 or none, −1 or +3, +2 or −2, +1 or −3 sub-frames). These can be used by the metadata to transmit determiner for constructing the spatial metadata frame.

In some embodiments any determination without an offset decision may keep the offset detected in the previous frame or set the offset to 0. In some embodiments the specific ordering of the determinations may differ from those in FIG. 15 without changing the final outcome as a function of the inputs.

The metadata to transmit determiner 1305 as discussed earlier is configured to obtain or receive the spatial metadata 104 and the determined asynchrony 1300 and based on the determined asynchrony 1300 determine the metadata to be encoded. In some embodiments, the metadata is determined by metadata interpolation.

For example when the coding mode is high temporal resolution mode (4sf), the metadata sub-frames of the current frame sf(0,1), sf(0,2), sf(0,3), sf(0,4) are provided to the further analysis/processing/encoding as-is.

When the coding mode is a low temporal resolution (or high frequency resolution) mode (1sf), a single prototypal metadata sub-frame sf(0, ξ) is determined that represents the 4 metadata sub-frames to transmit/encode sf(0,1), sf(0,2), sf(0,3), sf(0,4).

In some embodiments this single prototypal metadata sub-frame can be achieved by selecting one of the sub-frames to be a representative sub-frame for the entire frame and only use the selected one. This can be represented as:

$$sf ( 0 , ξ ) = sf ( 0 , 1 ) .$$

It would be understood the representative sub-frame for the entire frame can be any other sub-frame.

This is a suitable solution for example in the case of 1sf mode when the offset is equal to 0 (as all the sub-frames contain identical data).

However, in some embodiments, a selected sub-frame may not represent all the sub-frames in the frame optimally with other offsets, so in some embodiments the sub-frame to be encoded is determined in a different manner.

For example in some embodiments the metadata to transmit determiner is configured to compute an aggregation function over the sub-frames for determining the prototypal sub-frame sf(0, ξ).

An example of such an aggregation function is a vector average of the directional spatial metadata. This average can be weighted with the signal energy, weighting based on the sub-frame location within the frame, or some other weighting function. The following example describes on employing transport signal energy for the weighting.

The transport signal can be denoted with xᵢ(t), where i is the index of the transport channel and t is the time index. The transport signal can be converted into time-frequency domain, e.g., with the use of a complex modulated low delay filter bank (CLDFB). The signal in this domain can be denoted with Xᵢ(k, n), where k is frequency bin index and n is the slot index (time and frequency are now in CLDFB slots and bins, which may be different from the MASA parameter tile definitions). The transport signal energy E in MASA parameter TF-tile (b, s) (where b band and s is sub-frame) can be estimated by

$${E}_{b , s} = {\sum }_{k ∈ b} {\sum }_{n ∈ s} {\sum }_{i} {\vert {X}_{i} ( k , n ) \vert}^{2}$$

In this example, one or more CLDFB slots n are grouped into parameter sub-frames s, and one or more CLDFB bins k are grouped into parameter bands b. In the preferred embodiment, each parameter time sub-frame s corresponds to one of the spatial sub-frames sf(0,1), sf(0,2), sf(0,3), and sf(0,4). In other words sf(0, s).

The parameter band index b is not visible in the sub-frame structure and is often determined by the available bitrate. Alternatively, the computation can be performed at the full 24 bands of MASA parametrization. Each spatial metadata sub-frame sf(0, s) contains values for azimuth θ_{b,s}, elevation φ_{b,s}, and direct-to-total energy ratio r_{b,s}. The aggregated azimuth θ_{b,ξ}, elevation φ_{b,ξ}, and direct-to-total energy ratio r_{b,ξ} parameters (i.e., they depict all the subframes s of the frame ξ) are computed by interpreting the per-sub-frame parameter values as spherical coordinates and transforming them into Cartesian representation x_{b,s}, y_{b,s}, z_{b,s} with

$$\{ \begin{matrix}{x}_{b , s} = cos ( {θ}_{b , s} ) cos ( {ϕ}_{b , s} ) {r}_{b , s} {E}_{b , s} \\ {y}_{b , s} = sin ( {θ}_{b , s} ) cos ( {ϕ}_{b , s} ) {r}_{b , s} {E}_{b , s} \\ {z}_{b , s} = sin ( {ϕ}_{b , s} ) {r}_{b , s} {E}_{b , s}\end{matrix}$$

These are then averaged/summed over the sub-frames s∈[1,4] with

$$\{ \begin{matrix}{x}_{b . ξ} = \frac{1}{N} {\sum }_{s ∈ {ξ}^{{x}_{b , s}}} \\ {y}_{b . ξ} = \frac{1}{N} {\sum }_{s ∈ ξ} {y}_{b , s} \\ {z}_{b . ξ} = \frac{1}{N} {\sum }_{s ∈ {ξ}^{{Z}_{b , s}}}\end{matrix}$$

and converted back into spherical coordinate parameterization with

$$\{ \begin{matrix}{θ}_{b , ξ} = {tan}^{- 1} \frac{{y}_{b . ξ}}{{x}_{b . ξ}} \\ {ϕ}_{b , ξ} = {tan}^{- 1} \frac{{z}_{b . ξ}}{\sqrt{{x}_{b . ξ}^{2} + {y}_{b . ξ}^{2}}} \\ {r}_{b , ξ} = \frac{\sqrt{{x}_{b . ξ}^{2} + {y}_{b . ξ}^{2} + {z}_{b . ξ}^{2}}}{{E}_{b , ξ}}\end{matrix}$$

$$where$$

$${E}_{b , ξ} = \frac{1}{N} {\sum }_{s ∈ ξ} {E}_{b , s}$$

and the tan⁻¹( ) is the arcus tangent (or inverse tangent) variant resolving the correct quadrant.

The spread coherence parameter

$${c}_{b , ξ}^{spr}$$

can be determined as an energy-weighted average of the per-sub-frame values

$${c}_{b , s}^{spr}$$

with

$${c}_{b , ξ}^{spr} = \frac{1}{{E}_{b , ξ}} {\sum }_{s ∈ ξ} {E}_{b , s} {c}_{b , s}^{spr}$$

Similarly, the surround coherence parameter

$${c}_{b , ξ}^{sur}$$

can be determined as an energy-weighted average of the per-sub-frame values

$${c}_{b , s}^{sur}$$

with

$${c}_{b , ξ}^{sur} = \frac{1}{{E}_{b , ξ}} {\sum }_{s ∈ ξ} {E}_{b , s} {c}_{b , s}^{sur}$$

As mentioned earlier, some other weighting can be used in the place of the transport signal energy E_{b,s}, however the operations remain otherwise similar.

The spatial metadata parameters for sf(0, ξ) for the band b represent the result from the aggregation/interpolation over sub-frames. This sub-frame metadata can be replicated to all sub-frames of the current frame replacing the original values:

$$\text{?} ( 0 , 1 ) = \text{?} ( 0 , 2 ) = \text{?} ( 0 , 3 ) = \text{?} ( 0 , 4 ) = \text{?} ( 0 , ξ )$$

and these sub-frames are then used in the further analysis and encoding normally. The determiner can then replace the spatial metadata 104 or include them in the spatial metadata frame.

The result of these embodiment is metadata in 1sf (low temporal resolution (or high frequency resolution)) mode not requiring further alignment in the decoder. In 4sf (high temporal resolution) mode, no adjustment is implemented, and the spatial metadata frame is handled without further modification.

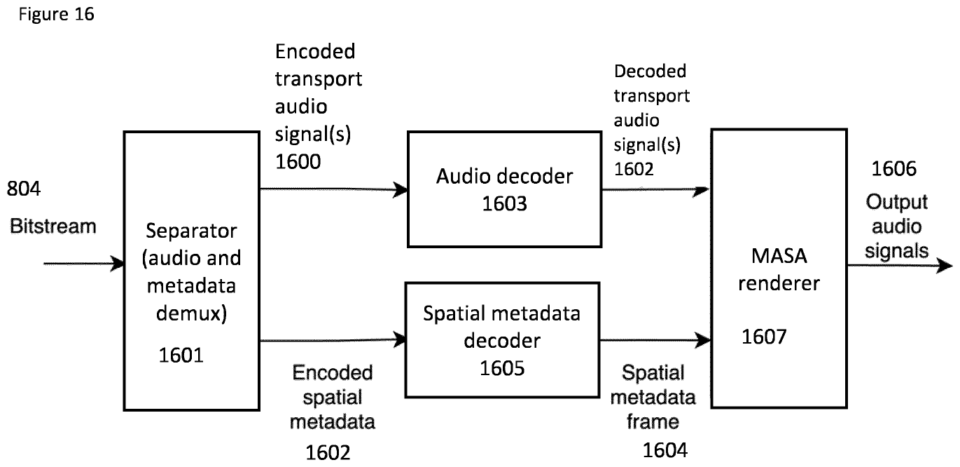

With respect to FIG. 16 is shown an example known decoder 803, such as shown in FIG. 8 in further detail.

The decoder is configured to receive the bitstream 804. The decoder 803 in some embodiments comprises a separator which is configured to unpack the bitstream 804 and separate and output the encoded transport audio signal 1600 and encoded spatial metadata 1600.

The encoded transport audio signals 1600 is then provided to an audio decoder 1603 and decode this to provide transport audio signals 1602.

The encoded spatial metadata 1602 is further processed by a spatial metadata decoder 1605 which then provides a spatial metadata frame 1604 to a (MASA) renderer 1606.

The (MASA) renderer 1606 is configured to use the spatial metadata frame 1604 to determine output audio signals 1606 from the transport audio signals 1606. The (MASA) renderer 1606 can in some embodiments (as discussed earlier) be implemented inside the (IVAS) decoder implementation, or it can be a so-called external renderer.

The decoder however, because of the operations of the embodiments discussed above of the encoder, can be implemented using any suitable known method.

In some embodiments the asynchrony analyser 1303 as discussed above make use of the spatial metadata from the previous frame. However, in some circumstances the spatial metadata from the previous frame is not available. For example, due to limitations of working memory.

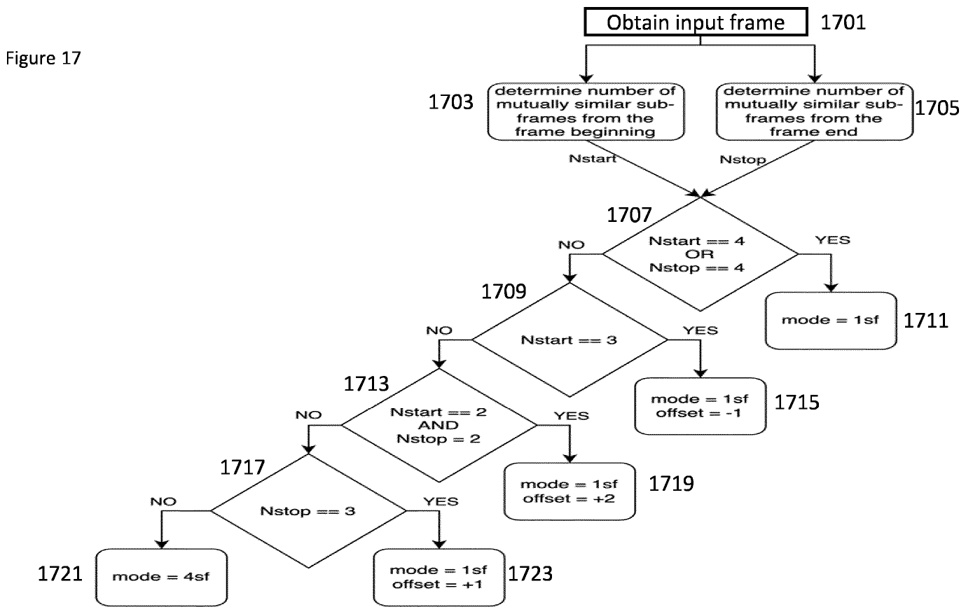

In some embodiments, such as shown in the flow diagram FIG. 17, an asynchrony analysis can be implemented by the asynchrony analyser 1303 without requiring the previous frame (or history frame).

In other words the analyser 1303 determines the analysis based on the metadata sub-frames (such as shown in FIG. 12) sf(0,1), sf(0,2), sf(0,3), and sf(0,4) to detect framing asynchrony.

The analysis illustrated in the flow diagram in FIG. 17 shows obtaining the input frame as shown by 1701.

As shown by 1703 is a determination of a number of mutually similar sub-frames from the frame beginning. The determination can generate a Nstart value.

There is also shown by 1705 a determination of a number of mutually similar sub-frames from the frame ending. The determination can generate a Nstop value.

Then a determination can be made to determine whether the Nstart value is 4 or the Nstop value is 4 as shown by 1707.

If either Nstart value is 4 or the Nstop value is 4 then the determined asynchrony output is one which assigns or fixes a mode of 1sf as shown by 1711.

Else a further determination can be made to determine whether the Nstart value is 3 as shown by 1709.
If the Nstart value is 3 then the determined asynchrony output is one which assigns or fixes a mode of 1sf but with an offset value of −1 (subframe) as shown by 1715.
Else a further determination can be made to determine whether the Nstart value is 2 and the Nstop value is 2 as shown by 1713.
   If the Nstart value is 2 and the Nstop value is 2 then the determined asynchrony output is one which assigns or fixes a mode of 1sf but with an offset value of +2 (subframes) as shown by 1719.
   Else a further determination can be made to determine whether the Nstop value is 3 as shown by 1717.
      If the Nstop value is 3 then the determined asynchrony output is one which assigns or fixes a mode of 1sf but with an offset value of +1 (subframe) as shown by 1723.
      Else the determined asynchrony output is one which assigns or fixes a mode of 4sf as shown by 1721.

In other words, for some embodiments, the analyser is configured to determine the number of mutually similar sub-frames from the beginning and from the end of the current frame, Nstart and Nstop. These values are then used to determine the frame mode and offset. The remaining operations of the encoder and the decoder can be implemented as presented previously.

The two example embodiments presented above describe alternative examples aiming to improve the audio quality.

In some embodiments a selection of the whether to employ a history based or non-history based embodiment may be performed based on implementation constraints. For example an apparatus with limited inter-frame memory.

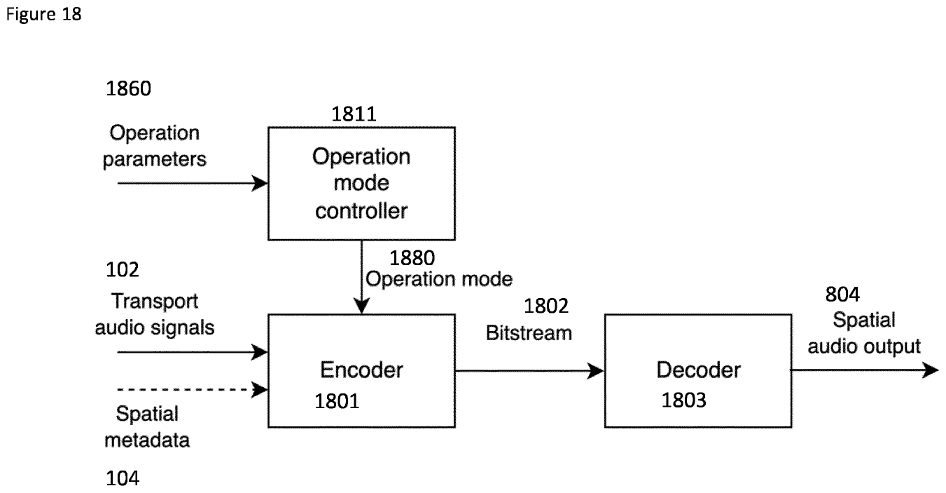

For example as shown in FIG. 18 is an example wherein the encoder 1801 which is similar to the encoder 801 as shown in FIG. 8, but with an additional input referred as operation mode 1880. The operation mode can select which of the above embodiments to employ.

Furthermore the operation mode 1880 can be determined by an operation mode controller 1811. The operation mode controller 1811 is configured to receive operation parameters 1860, for example, a total allowable complexity or memory and based on these select the operation mode that is most fitting to the given operation parameters.

For example in some embodiments the encoder may have constraints on the usage of the memory. The constraints for the metadata encoding may be different at different bitrates. So, as an example, the operation parameters could also comprise a total bitrate for encoding the input signals.

The operation mode controller could for example in some embodiments be configured to select the asynchrony analysis method based on the used bitrate and the pre-determined memory constraint for that bitrate.

In the examples shown above Complex-Values Low-Delay Filter Bank (CLDFB) as the frequency-domain representation other methods of time-frequency domain representation can be employed, such as Short-time Fourier Transform (STFT) or Quadrature Mirrored Filterbank (QMF).

The parametric format described above has been MASA format but the embodiments can be extended to other parametric formats such as parametric coding of Ambisonics or multi-channel mixes.

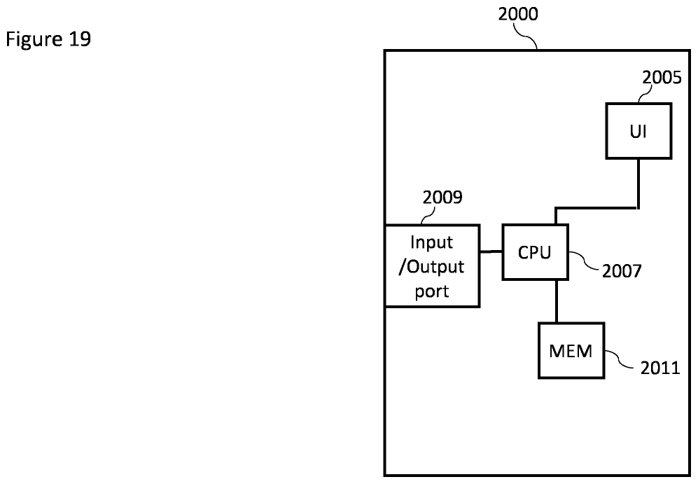

With respect to FIG. 19 an example electronic device which may be used as any of the apparatus parts of the system as described above. The device may be any suitable electronics device or apparatus. For example, in some embodiments the device 2000 is a mobile device, user equipment, tablet computer, computer, audio playback apparatus, etc. The device may for example be configured to implement the encoder and/or decoder or any functional block as described above.

In some embodiments the device 2000 comprises at least one processor or central processing unit 2007. The processor 2007 can be configured to execute various program codes such as the methods such as described herein.

In some embodiments the device 2000 comprises at least one memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore, in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example, the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example, in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.
   This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor; and at least one memory storing instructions that, when executed by the at least one processor, cause the apparatus at least to:
obtain at least one spatial metadata parameter associated with at least one audio signal, the at least one spatial metadata parameter being arranged in frames comprising at least two sub-frames;
obtain asynchrony information, wherein the asynchrony information is based on asynchrony between a sequence of at least two time sub-frames containing similar values and a frame for further processing the at least one spatial metadata parameter; and
process the frame comprising the at least two time sub-frames based on the asynchrony information, such that the processed frame comprising the at least two time sub-frames of at least one spatial metadata parameter is able to be further processed.

2. The apparatus as claimed in claim 1, wherein the sequence of at least two time sub-frames containing similar values is one of:
located within the same frame; and
located over two consecutive frames.

3. The apparatus as claimed in claim 1, wherein the apparatus is further caused to process the processed frame comprising the at least two time sub-frames of at least one spatial metadata parameter.

4. The apparatus as claimed in claim 3, wherein the apparatus caused to process the at least one spatial metadata parameter processed frame comprising the at least two time sub-frames is caused to encode the processed frame comprising the at least two time sub-frames of at least one spatial metadata parameter.

5. The apparatus as claimed in claim 1, wherein the apparatus is further caused to:
obtain the at least one audio signal; and
encode the at least one audio signal.

6. The apparatus as claimed in claim 1, wherein the apparatus caused to obtain asynchrony information is caused to one of:
analyze the at least one spatial metadata parameter to determine the asynchrony information;
receive the asynchrony information from at least one further apparatus having determined the asynchrony information; and
receive the asynchrony information from at least one further apparatus having analysed the at least one spatial metadata parameter to determine the asynchrony information.

7. The apparatus as claimed in claim 1, wherein the apparatus caused to obtain asynchrony information is caused to obtain an offset value identifying a temporal difference between the sequence of at least two time sub-frames and the encoding frame, the temporal difference obtained as a number of sub-frames.

8. The apparatus as claimed in claim 7, wherein the apparatus caused to process the sequence of the at least two time sub-frames based on the asynchrony information is caused to process the at least one spatial metadata parameter based on the offset value.

9. The apparatus as claimed in claim 8, wherein the apparatus caused to process the at least one spatial metadata parameter based on the offset value is caused to process a single spatial metadata parameter sub-frame to represent the at least two time sub-frames based on the processing of the sequence of the at least two time sub-frames.

10. The apparatus as claimed in claim 9, wherein the apparatus caused to generate a single spatial metadata parameter sub-frame to represent the at least two time sub-frames based on the processing of the sequence of the at least two time sub-frames is caused to one of:
select one of the at least two sub-frames to be the single spatial metadata parameter sub-frame; and
determine an aggregation of the at least two sub-frames to be the single spatial metadata parameter sub-frame.

11. The apparatus as claimed in claim 10, wherein the apparatus caused to determine an aggregation of the at least two sub-frames to be the single spatial metadata parameter sub-frame is caused to one of:
determine an aggregation function based on a vector average of a directional component of the at least one spatial metadata parameter; and
determine an aggregation function based on a vector average of a directional component of the at least one spatial metadata parameter weighted by a signal energy weighting.

12. The apparatus as claimed in claim 1, wherein the apparatus caused to obtain asynchrony information is caused to obtain an encoding mode identifying an encoding mode for encoding the at least one spatial metadata parameter based on the asynchrony information.

13. The apparatus as claimed in claim 6, wherein the apparatus caused to analyze the at least one spatial metadata parameter to determine the asynchrony information is caused to:
analyze for a current frame at least one spatial metadata parameter associated with the at least one audio signal to determine: a number of mutually similar sub-frames from the current frame start and a number of mutually similar sub-frames from the current frame end; and
determine the asynchrony information based on the number of mutually similar sub-frames from the current frame start and/or the number of mutually similar sub-frames from the current frame end.

14. The apparatus as claimed in claim 13, wherein the apparatus caused to analyze the at least one spatial metadata parameter to determine the asynchrony information is further caused to:
analyze for a last-sub-frame of a previous frame and a first-sub-frame of a current frame whether these are mutually similar sub-frames; and
obtain for the previous frame a number of mutually similar sub-frames,
wherein the apparatus caused to determine the asynchrony information based on the number of mutually similar sub-frames from the current frame start and/or the number of mutually similar sub-frame from the current frame end is further caused to determine the asynchrony information based on whether the last-sub-frame of a previous frame and a first-sub-frame of a current frame are mutually similar sub-frames and the number of mutually similar sub-frames for the previous sub-frame.

15. A method for an apparatus, the method comprising:
obtaining at least one spatial metadata parameter associated with at least one audio signal, the at least one spatial metadata parameter being arranged in frames comprising at least two sub-frames;
obtaining asynchrony information, wherein the asynchrony information is based on asynchrony between a sequence of at least two time sub-frames containing similar values and a frame for further processing the at least one spatial metadata parameter; and
processing the frame comprising the at least two time sub-frames based on the asynchrony information, such that the processed frames comprising the at least two time sub-frames of at least one spatial metadata parameter is able to be further processed.

16. The method as claimed in claim 15, wherein the sequence of at least two time sub-frames containing similar values is one of:
located within the same frame; and
located over two consecutive frames.

17. The method as claimed in claim 15, further comprising processing the processed frame comprising the at least two time sub-frames of at least one spatial metadata parameter by encoding the processed frame comprising the at least two time sub-frames of at least one spatial metadata parameter.

18. (canceled)

19. (canceled)

20. The method as claimed in claim 15, wherein obtaining asynchrony information comprises one of:
analysing the at least one spatial metadata parameter to determine the asynchrony information;
receiving the asynchrony information from at least one further apparatus having determined the asynchrony information; and
receiving the asynchrony information from at least one further apparatus having analysed the at least one spatial metadata parameter to determine the asynchrony information.

21-26. (canceled)

27. The method as claimed in claim 20, wherein analysing the at least one spatial metadata parameter to determine the asynchrony information comprises:
analysing for a current frame at least one spatial metadata parameter associated with the at least one audio signal to determine: a number of mutually similar sub-frames from the current frame start and a number of mutually similar sub-frames from the current frame end; and
determining the asynchrony information based on the number of mutually similar sub-frames from the current frame start and/or the number of mutually similar sub-frames from the current frame end.

28. The method as claimed in claim 27, wherein analysing the at least one spatial metadata parameter to determine the asynchrony information further comprises:
analysing for a last-sub-frame of a previous frame and a first-sub-frame of a current frame whether these are mutually similar sub-frames; and
obtaining for the previous frame a number of mutually similar sub-frames,
wherein determining the asynchrony information based on the number of mutually similar sub-frames from the current frame start and/or the number of mutually similar sub-frame from the current frame end further comprises determining the asynchrony information based on whether the last-sub-frame of a previous frame and a first-sub-frame of a current frame are mutually similar sub-frames and the number of mutually similar sub-frames for the previous sub-frame.
